(19) United States
(12) Patent Application Publication
(10) Pub. No.: US 2004/0189291 A1
(43) Pub. Date: Sep. 30, 2004

(54) Pipe material discrimination

(76) Inventor: John Ferris Burd, Nottingham (GB)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/479,161

(22) PCT Filed: May 28, 2002
(86) PCT No.: PCT/GB02/02242

(30) Foreign Application Priority Data
Jun. 1, 2001 (GB) 0113206.7

(51) Int. Cl. G01N 27/82

(52) U.S. Cl. 324/239; 324/240; 324/238; 324/220

(57) ABSTRACT

A method for determining the material from which an underground pipe is made. The method exposes a portion of the pipe, applies a coil having a primary winding and a secondary winding to the exposed portion of pipe such that the pipe contributes to an inductive coupling between the primary winding and the secondary winding, applies an excitation current to the primary winding to induce in the secondary winding a signal indicative of an induction value of the pipe, and determines the material from which the pipe is made dependent upon the signal induced in the secondary winding.

The present invention relates to the determination of the material from which pipes are made, particularly underground utility pipes such as gas pipes.

The gas pipe network includes underground pipes made from various types of metal, particularly pit cast iron, spun iron, ductile iron (all three being types of cast iron) and steel. Each type of metal is susceptible to different types of degradation to different extents e.g. corrosion stress, brittleness etc. and so requires replacement, maintenance or repair at different intervals dependent upon the material from which it is made. It is thus important to be able to determine reliably from what material a pipe is made. Conventionally, the material from which an existing pipe in a gas network is made is determined by excavating to expose a portion of the pipe, taking a sample of the pipe and examining it under a microscope. However, this is a time consuming, inconvenient and expensive exercise. It is an object of the present invention to determine the material from which a pipe is made by a method which alleviates at least one of the drawbacks of prior methods.

According to a first aspect of the present invention, there is provided a method for determining the material from which an underground pipe is made, the method comprising:

exposing a portion of the pipe;

applying a coil means having a primary winding and a secondary winding to the exposed portion of pipe such that the pipe contributes to an inductive coupling between the primary winding and the secondary winding;

applying an excitation current to the primary winding to induce in the secondary winding a signal indicative of an induction value of the pipe; and

determining the material from which the pipe is made dependent upon the signal induced in the secondary winding.

This method is far quicker than the conventional method which requires pipe samples to be sent away for analysis.

The material from which the pipe is made may be determined by comparing the signal induced in the secondary winding to previously induced signals using pipes of known materials.

The coil means may comprise a metal yoke with the primary and secondary windings wound around a portion of its length. The yoke is preferably made from granules of iron or powdered iron with granules coated with non-conducting material. The coated granules are preferably pressed and sintered together.

According to a second aspect of the present invention, there is provided an apparatus for determining the material from which an underground pipe is made, the apparatus comprising:

a coil means having a primary winding and a secondary winding, the coil means being arranged to be applied to an exposed portion of a pipe such that the pipe contributes to an inductive coupling between the primary winding and the secondary winding;

means for applying an excitation current to the primary winding to induce in the secondary winding a signal indicative of an induction value of the pipe; and

means for determining the material from which the pipe is made dependent upon the signal induced in the secondary winding.

The determining means preferably compares the signal induced in the second winding to previously induced signals using pipes of known materials.

The coil means may comprise a metal yoke with the primary and secondary windings wound around a portion of its length. The yoke is preferably made from granules of iron or powdered iron coated with non-conducting material. The coated granules may be pressed and sintered together.

An example of a method and apparatus for determining the material from which a pipe is made will now be described with reference to the accompanying drawings in which:

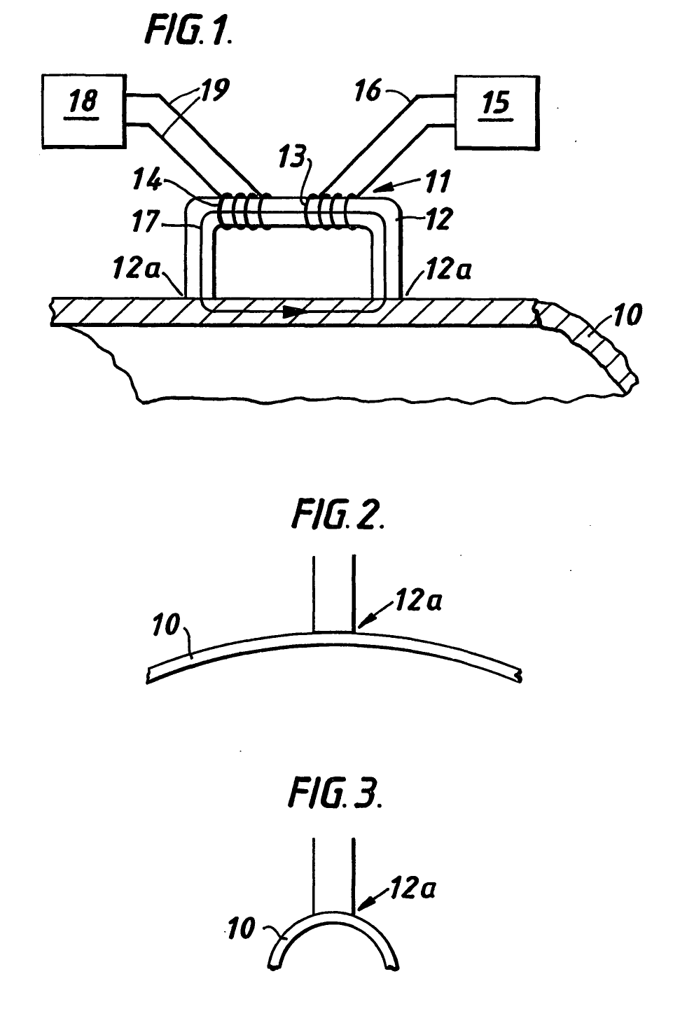

FIG. 1 shows an apparatus for determining the material from which a pipe is made, the apparatus being applied to a pipe;

FIG. 2 is a cross sectional view of a portion of the apparatus applied to a relatively large diameter pipe; and

FIG. 3 is a cross sectional view of a portion of the apparatus applied to a relatively small diameter pipe.

As shown in FIG. 1, a portion of an underground pipe 10 is exposed by excavating around that portion of the pipe 10. An exposed portion of the pipe 10 then has a coil means 11 applied to it. The coil means 11 in this example comprises an iron yoke 12 with a primary coil 13 and a secondary coil 14 wrapped around it. The coils 13, 14 are spaced from each other along the yoke 11.

The primary coil 13 acts as a driver coil and is connected to an excitation means 15 which in this example generates an alternating current which is passed through wires 16 to the primary coil 13. The alternating current in primary coil 13 generates a magnetic circuit 17 through the yoke 12 and the portion of the pipe wall 10 between the two portions of the yoke 12a which are adjacent the pipe 10. The magnetic circuit 17 generates an alternating current in the secondary coil 14 acting as a sensor coil. The generated alternating current is detected using a detector 18 which is connected to the secondary coil through wires 19. In this example, the detector 18 comprises a rectifier to convert the alternating current into a direct current and a voltmeter.

There are a number of ways of using the signal induced in the secondary coil 14 to determine what material the pipe is made from. Since the strength or amplitude of the output signal is dependent upon the efficiency of the magnetic circuit through the yoke 12 and pipe wall 10, any variation in the material of the pipe wall will affect the efficiency of the magnetic circuit and therefore the output signal measured by detector 18. The present invention thus effectively measures the permeability of the material of the pipe. By predetermining the strength or amplitude of the output signal for a number of pipes of known material using the rectifier and voltmeter of detector 18, the output from a pipe under test can be compared to these predetermined outputs to determine what material the pipe is made from.

Alternatively, the excitation means could apply a sweep of frequencies to the primary coil 13. Pipes of different material will produce a peak at different frequencies. By predetermining the peak frequency for pipes of different material, the peak frequency for a pipe under test can be compared to these predetermined data to determine what material it is made from.

The yoke 12 may be made from laminated iron sections to reduce the effect of eddy currents which form and oppose and so reduce the effect of the magnetic circuit 17. However, the yoke 12 is preferably formed from powdered or granulated iron with the granules coated with a non-conducting material and the coated granules pressed and sintered together. This reduces the eddy currents even more than forming the yoke 12 from laminated sections and so produces even- clearer, more precise results.

To provide good contact between the yoke 12 and the pipe 10 for pipes of different diameters, the cross-sections of the portions of the yoke 12a to be brought into contact with the pipe may be provided with appropriate curvatures to their surfaces. For example, when used with a large diameter pipe as shown in FIG. 1 and in the corresponding side view of FIG. 2, the cross-sections of the portions of the yoke 12a to be brought into contact with the pipe have only a slight curvature, if any curvature at all. In contrast when used with pipes of relatively small diameter e.g. 8 cm as shown in FIG. 3, the cross-sections of the portions of the yoke 12a to be brought into contact with the pipe 10 may have a distinct curvature to enable the yoke to have good contact with the pipe 10 to produce reliable measurements.

1-14 (Canceled).

15. A method for determining a material from which an underground pipe is made, the method comprising:
exposing a portion of the pipe;
applying a coil having a primary winding and a secondary winding to the exposed portion of the pipe such that the pipe contributes to an inductive coupling between the primary winding and the secondary winding;
applying an excitation current to the primary winding to induce in the secondary winding a signal indicative of an induction value of the pipe; and
determining the material from which the pipe is made dependent upon the signal induced in the secondary winding.

16. A method according to claim 15, wherein the material from which the pipe is made is determined by comparing the signal induced in the secondary winding to previously induced signals using known materials.

17. A method according to claim 16, wherein the signal induced in the secondary winding is rectified to produce a voltage to be compared to predetermined voltages of known materials.

18. A method according to claim 15, wherein the coil comprises a metal yoke with the primary and secondary windings wound around a portion of a length of the metal yoke.

19. A method according to claim 18, wherein the yoke is made from granular or powdered iron coated with non-conducting material and pressed together.

20. A method according to claim 15, wherein a cross-section of a portion of the coil to be applied to the exposed portion of pipe has a curvature to provide good contact between the coil and the pipe.

21. An apparatus for determining a material from which an underground pipe is made, the apparatus comprising:
a coil having a primary winding and a secondary winding, the coil configured to be applied to an exposed portion of a pipe such that the pipe contributes to an inductive coupling between the primary winding and the secondary winding;
means for applying an excitation current to the primary winding to induce in the secondary winding a signal indicative of an induction value of the pipe; and
means for determining the material from which the pipe is made dependent upon the signal induced in the secondary winding.

22. An apparatus according to claim 21, wherein the means for determining the material from which the pipe is made is arranged to compare the signal induced in the secondary winding to previously induced signals using known materials.

23. An apparatus according to claim 22, wherein the means for determining includes a rectifier to produce a voltage to be compared to predetermined voltages of known materials.

24. An apparatus according to claim 21, wherein the coil comprises a metal yoke with the primary and secondary windings wound around a portion of a length of the metal yoke.

25. An apparatus according to claim 24, wherein the yoke is made from granular or powdered iron coated with non-conducting material pressed together.

26. An apparatus according to claim 21, wherein a cross-section of a portion of the coil to be applied to the exposed portion of pipe has a curvature to provide good contact between the coil and the pipe.
